(19) United States
(12) Patent Application Publication
(10) Pub. No.: US 2025/0097498 A1
(43) Pub. Date: Mar. 20, 2025

(54) METHOD FOR PLAYING BACK PRESENTATION VIDEOS, METHOD FOR IDENTIFYING PRESENTATION VIDEOS, AND COMPUTER DEVICE

(71) Applicant: BEIJING DAJIA INTERNET INFORMATION TECHNOLOGY CO., LTD., Beijing (CN)

(72) Inventors: Lu BAI, Beijing (CN); Hongxin XU, Beijing (CN); Shujie TIAN, Beijing (CN); Xin ZHANG, Beijing (CN); Ye TIAN, Beijing (CN)

(21) Appl. No.: 18/639,820

(22) Filed: Apr. 18, 2024

(30) Foreign Application Priority Data
Sep. 19, 2023 (CN) 202311212193.2

(51) Int. Cl. H04N 21/262; H04N 21/2187; H04N 21/239; H04N 21/437; H04N 21/472; H04N 21/845

(52) U.S. Cl. CPC H04N 21/26258; H04N 21/2187; H04N 21/2393; H04N 21/437; H04N 21/47217; H04N 21/8456

(57) ABSTRACT

A method for playing back a presentation video is provided. The method includes: displaying a playback interface for a presentation video in response to a trigger operation on the presentation video; displaying a segment topic in the playback interface; and playing back a target sub-video corresponding to the segment topic in response to an operation on the segment topic. The segment topic is determined based on content identification of a segment in the presentation video, and the target sub-video includes segments with the same segment topic.

This application is based on and claims priority to Chinese Patent Application No. 202311212193.2, filed on Sep. 19, 2023, the disclosure of which is herein incorporated by reference in its entirety.

### TECHNICAL FIELD

The present disclosure relates to the technical field of video processing, and in particular, relates to a method for playing back presentation videos, a method for identifying presentation videos, and a computer device thereof.

### BACKGROUND

As more users prefer online shopping, a lot of live streaming platforms are provided for better services to users. It is possible to explain products via live streaming based on the live streaming platform, and some live streaming platforms also provide users with a function of playing back the presentation video. This function helps users to understand the content of the presentation more quickly.

### SUMMARY

Embodiments of the present disclosure provide a method for playing back presentation videos, a method for identifying presentation videos, and a computer device, which are capable of improving the efficiency of human-computer interactions.

According to one aspect of the embodiments of the present disclosure, a method for playing back presentation videos. The method includes: displaying a playback interface for a presentation video in response to a trigger operation on the presentation video; displaying a segment topic in the playback interface, wherein the segment topic is determined based on content identification of a segment in the presentation video; and playing back a target sub-video corresponding to the segment topic in response to an operation on the segment topic, wherein the target sub-video comprises segments with a same segment topic.

According to a second aspect of the embodiments of the present disclosure, a method for identifying presentation videos is provided. The method includes: acquiring segment topics of respective segments by performing content identification on the respective segments in the presentation video; acquiring at least one target sub-video by reorganizing segments with a same segment topic, wherein each of the at least one target sub-video corresponds to one of the segment topics; and embedding the segment topic into the corresponding target sub-video.

According to a third aspect of the embodiments of the present disclosure, a computer device is provided. The computer device includes a processor and a memory. The memory stores at least one program therein. The at least one program, when loaded and run by the processor of the computer device, causes the computer device to display a playback interface for a presentation video in response to a trigger operation on the presentation video; display a segment topic in the playback interface, wherein the segment topic is determined based on content identification of a segment in the presentation video; and play back a target sub-video corresponding to the segment topic in response to an operation on the segment topic, wherein the target sub-video includes segments with a same segment topic.

### BRIEF DESCRIPTION OF DRAWINGS

FIG. 1 is a schematic diagram of an implementation environment according to some embodiments of the present disclosure;

FIG. 2 is a schematic diagram of a flowchart of a method for playing back presentation videos according to some embodiments of the present disclosure;

FIG. 3 is a schematic diagram of an example flowchart of a method for playing back presentation videos according to some embodiments of the present disclosure;

FIG. 4A is a schematic diagram of a playback interface according to some embodiments of the present disclosure;

FIG. 4B is a schematic diagram of a playback interface according to some embodiments of the present disclosure;

FIG. 5 is a schematic diagram of a flowchart of a method for identifying presentation videos according to some embodiments of the present disclosure;

FIG. 6 is a schematic diagram of an example flowchart of a method for identifying presentation videos according to some embodiments of the present disclosure;

FIG. 7 is a schematic structural diagram of a playback apparatus for a presentation video according to some embodiments of the present disclosure;

FIG. 8 is a schematic structural diagram of an identification apparatus for a presentation video according to some embodiments of the present disclosure;

FIG. 9 is a schematic structural diagram of a terminal according to some embodiments of the present disclosure; and

FIG. 10 is a schematic structural diagram of a server according to some embodiments of the present disclosure.

### DETAILED DESCRIPTION

It should be noted that the data (including, but not limited to, training data for training models, e.g., sample videos and corresponding content topic tags) and signals involved in the present application are information and data that have been authorized by the user or have been fully authorized by the parties. The collection, use, and processing of the relevant data need to comply with the relevant laws, regulations, and standards of the relevant countries and regions. For example, the videos and the like in the target storage space involved in this application are acquired under full authorization.

In the related art, to achieve the function of playing back presentation videos, a live streaming platform saves a presentation video generated during live streaming, and then adds a presentation topic to the presentation video, such that a user could play back the presentation video. However, with this method, the user needs to perform operations such as a progress control to jump back and forth to locate a segment of the presentation video that he or she wants to watch, which greatly reduces the interaction efficiency.

In some embodiments of the present disclosure, a segment topic is displayed in a playback interface for a presentation video, and a target sub-video corresponding to the segment topic is played back in response to an operation on the segment topic. In this way, the user can operate on the segment topic, then various segments with this segment topic in the entire presentation video are quickly located by one location operation, and the various segments with this segment topic are played back. Therefore, there is no need to locate the segments that the user wants to watch in the presentation video by performing operations such as jumping back and forth, which greatly improves the efficiency of human-computer interaction.

In some embodiments of the present disclosure, a server identifies content of each segment of the presentation video, acquires a segment topic of each segment, and embeds the segment topic into a corresponding target sub-video. Because the server automatically identifies the content of the presentation video and acquires the target sub-video, there is no need to add the segment topic to each presentation video, such that the processing efficiency of the presentation video is improved. In addition, by embedding the segment topic into the corresponding target sub-video, any terminal displays the segment topic during the playback of the presentation video, and by performing an operation on the segment topic, the target sub-video corresponding to the segment topic is played back. That is, all the segments with this segment topic are played back at one time. In this way, the user accurately locates the target sub-video according to the segment topic without jumping back and forth to locate a segment that he or she wants to watch, which improves the interaction efficiency of the user.

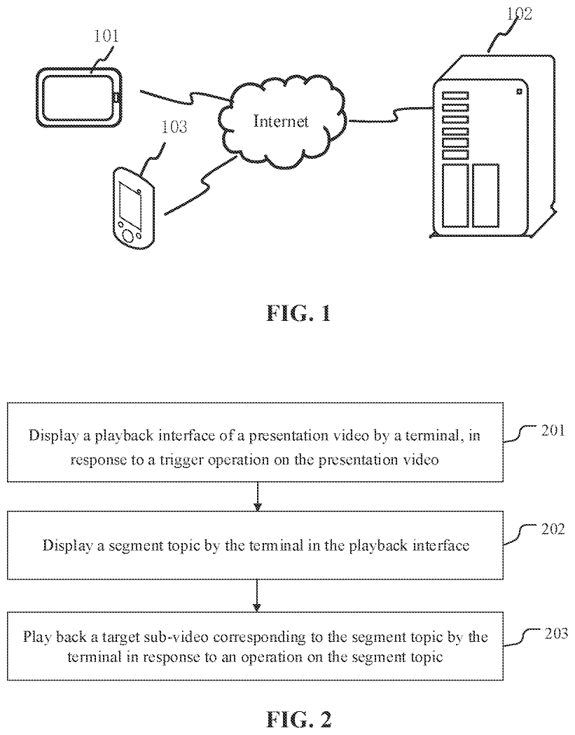

FIG. 1 is a schematic diagram of an implementation environment according to some embodiments of the present disclosure. The implementation environment includes a first terminal 101, a server 102, and a second terminal 103.

Applications provided by the server 102 are running in both the first terminal 101 and the second terminal 102, such as social applications, live streaming applications, and resource interaction applications. A user accesses a live streaming platform provided by the server 102 through the applications to watch a presentation video on the live streaming platform.

The first terminal 101 and the second terminal 102 may be an electronic device such as a smartphone, a wearable device, a personal computer, a laptop computer, a tablet computer, a smart TV, a vehicle-mounted terminal, or the like. The first terminal 101 may be a terminal on which an audience user is logged in, and may include a plurality of terminals. The second terminal 102 may be a terminal on which an anchor is logged in.

The server 102 is a single server, a server cluster consisting of multiple servers, or a cloud processing center.

The first terminal 102 and the second terminal 103 are connected to the server 102 over a wired or wireless network.

In some embodiments, the wired network or wireless network uses standard communication technologies and/or protocols. The network is typically the Internet but may be any network including, but not limited to, a local area network (LAN), a metropolitan area network (MAN), a wide area network (WAN), a mobile, wired, or wireless network, a private network, or a virtual private network and any combinations thereof. In some embodiments, technologies and/or formats including hypertext markup language (HTML), extensible markup language (XML), and the like are used to represent data exchanged over the network. It is also possible to use conventional encryption technologies such as Secure Socket Layer (SSL), Transport Layer Security (TLS), virtual private network (VPN), and Internet Protocol Security (IPsec) to encrypt all or some of the links. In other embodiments, it is also possible to use customized and/or specialized data communication technologies to instead or supplement the data communication technologies described above.

FIG. 2 is a schematic diagram of a flowchart of a method for playing back presentation videos according to some embodiments of the present disclosure. As illustrated in FIG. 2, in some embodiments of the present disclosure, the description is given using a scenario where the method for playing back presentation videos is applicable to a terminal as an example. The method includes the following steps.

In step 201, a terminal displays a playback interface for a presentation video in response to a trigger operation on the presentation video.

The trigger operation on the presentation video is a trigger operation on a cover image of the presentation video, a trigger operation on a presentation entrance of an item detail interface, or other operations performed on a control by a user of the terminal for triggering display of the playback interface. In some embodiments, the terminal displays a display interface of a live streaming platform in response to an access operation of a user on the live streaming platform. The display interface includes one or more presentation videos, each of the presentation videos includes a cover image, and each cover image includes an image of an item explained in the corresponding presentation video and a brief introduction of the item. The user determines general content of each presentation video based on the respective cover image, and then selects the presentation video to be played back. For example, the terminal, in response to the trigger operation of the user on the cover image of any of the presentation videos, jumps from the display interface of the live streaming platform to the playback interface for the presentation video.

In some embodiments, the terminal directly displays a progress control bar of the presentation video in the playback interface, wherein the progress control bar is configured to control a playback progress of the presentation video.

In some embodiments, the terminal displays the progress control bar of the presentation video in response to a touch operation of the user on the playback interface, wherein the touch operation is a double-tap operation on the playback interface, a slide operation according to a target track, or the like.

In some embodiments, the terminal runs with an application, and a server of the live streaming platform is accessed through the application, such that the presentation video provided by the server is played back by executing the method of the embodiments of the present application.

In step 202, the terminal displays a segment topic in the playback interface.

The segment topic is determined based on content identification of a segment in the presentation video, and thus the segment topic indicates a topic of the segment in the presentation video, i.e., a topic of the presentation content in the segment.

A target sub-video is acquired by reorganizing the presentation video. The target sub-video includes segments with the same segment topic. That is, segments, with the same segment topic, in the presentation video are reorganized into the target sub-video.

In some embodiments, step 202 includes displaying, in an image currently played on the playback interface, a segment topic of a segment to which the image belongs.

In the case that the terminal displays the playback interface for the presentation video in response to the trigger operation on the presentation video, the presentation video is played back based on the playback interface, images contained in the presentation video are displayed during the playback process, and a segment topic is displayed in an image currently played, wherein the segment topic is a segment topic of a segment to which the image currently played belongs. In this way, during the playback of the presentation video, the user can quickly understand a topic of the segment currently played, and in the case where the user wants to watch all the segments belonging to this topic at one time, he or she can perform an operation on the displayed segment topic, such that a target sub-video corresponding to this segment topic is played back. The target sub-video is configured to play back the segments with the segment topic successively.

In some embodiments, step 202 includes the following: the terminal plays back a segment corresponding to a progress control operation in the playback interface and displays a segment topic of the segment in response to the progress control operation on the playback interface.

The progress control operation is configured to control a playback progress of the presentation video. By performing the progress control operation on the playback interface, the playback progress is adjusted, and the segment in the playback interface is played back based on a playback progress corresponding to the progress control operation. For example, the presentation video is played back in the playback interface with a playback moment corresponding to the progress control operation as a starting point. Moreover, in the case that the playback moment corresponding to the progress control operation belongs to one of the segments in the presentation video, a segment topic of the segment is also displayed during the playback process according to the segment currently played.

In some embodiments, a progress control bar is arranged in the playback interface, and the terminal displays a segment topic in the playback interface in response to a progress control operation on the progress control bar in the playback interface.

In some embodiments, the progress control operation is a drag operation. In the process of performing the drag operation, a playback moment of a target image corresponds to an implementation position of the drag operation on the progress control bar. For example, a slider is arranged in the progress control bar, and the drag operation on the progress control bar is a drag operation on the slider. In the process of performing the drag operation, the playback moment of the target image corresponds to a position of the slider in the progress control bar after being dragged. Then the terminal displays the target image in the playback interface in response to the drag operation on the progress control bar in the playback interface, and a segment topic of a segment to which the target image belongs is displayed in the target image.

In some embodiments, the progress control operation is a click operation, and a playback moment of a target image corresponds to an implementation position of the click operation on the progress control bar. Then the terminal displays the target image in the playback interface in response to the click operation on the progress control bar in the playback interface, and a segment topic of a segment to which the target image belongs is displayed in the target image.

The target image is an image of a frame in the presentation video. In a case where the progress control operation is not performed, during the process of playing back the presentation video, the terminal plays back each frame in the presentation video one by one, and the target image, which displays the segment topic, is included in the played frames. If the user wants to watch all the segments belonging to this segment topic at one time, the user can perform an operation on the displayed segment topic so as to play back the target sub-video corresponding to the segment topic. Alternatively, the target image is a thumbnail acquired by scaling down a frame in the presentation video. When the terminal hovers the mouse over any playback moment of the progress control bar during the playback of the presentation video, a thumbnail of a target image corresponding to that playback moment is displayed, i.e., a thumbnail of a frame in the presentation video corresponding to that playback moment. The target image is displayed after the terminal performs a click operation on the playback moment, or the terminal moves the mouse to the thumbnail and clicks on the thumbnail. Both the target image and the thumbnail of the target image are displayed with a segment topic. In some embodiments, after displaying the target image, the display of the thumbnail of the target image is canceled. The method for displaying the target image is not limited herein.

In step 203, the terminal plays back a target sub-video corresponding to the segment topic in response to an operation on the segment topic.

The target sub-video includes segments with the same segment topic. In the case that a user operates on a segment topic, various segments with the segment topic are played back successively. That is, various segments with the same segment topic are played back one by one.

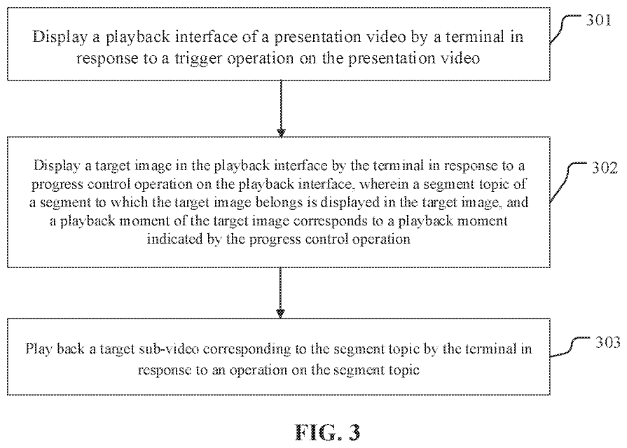

FIG. 2 is a schematic diagram of a flowchart of a method for playing back presentation videos according to some embodiments of the present disclosure. FIG. 3 is a schematic diagram of an example flowchart of a method for playing back presentation videos according to some embodiments of the present disclosure. The technical solution of the present disclosure is further described hereinafter based on FIG. 3. The description is given using a scenario where the method for playing back presentation videos is performed by a terminal as an example. The method includes the following steps.

In step 301, a terminal displays a playback interface for a presentation video in response to a trigger operation on the presentation video.

For the content of step 301, reference is made to step 201, which is not repeated herein.

In step 302, the terminal displays a target image in the playback interface in response to a progress control operation on the playback interface, wherein a segment topic of a segment to which the target image belongs is displayed in the target image, and a playback moment of the target image corresponds to a playback moment indicated by the progress control operation.

In some embodiments, the target image is an image of a frame in the presentation video, and the frame may include one or more pictures and embedded text information. In some embodiments, the target image is a thumbnail acquired by scaling down a screen in the presentation video. When the terminal hovers the mouse over any playback moment of the progress control bar during the playback of the presentation video, a thumbnail of a target image corresponding to that playback moment is displayed, i.e., a thumbnail of a frame in the presentation video corresponding to that playback moment. The target image is displayed after the terminal performs a click operation on the playback moment, or the terminal moves the mouse to the thumbnail and clicks on the thumbnail. Both the target image and the thumbnail of the target image are displayed with a segment topic. In some embodiments, after displaying the target image, the display of the thumbnail of the target image is canceled. The method for displaying the target image is not limited herein.

The playback interface further includes a progress control in addition to the target image. The progress control operation by a user indicates a playback moment of the presentation video, and the terminal plays back the presentation video with the playback moment indicated by the progress control operation as a starting point in response to the progress control operation on the playback interface. The playback moment of the target image is the playback moment indicated by that progress control operation.

A segment corresponding to the progress control operation is a segment to which the playback moment indicated by the progress control operation belongs, i.e., the segment to which the target image belongs, and the segment topic of the segment to which the target image belongs is displayed in the target image.

In some embodiments, using the progress control operation is a drag operation as an example, the terminal, in response to the drag operation on the progress control bar, successively displays, in the playback interface, a playback moment corresponding to an implementation position of the progress control operation on the progress control bar and a target image corresponding to the playback moment. Then a user learns about content of the target image corresponding to the implementation position of the progress control operation according to the information provided by the target image, such that the user accurately locates a playback moment that he or she wants to play back, without the need to locate a target sub-video that he or she wants to watch by jumping back and forth and other operations, and thus the interaction efficiency of the user is improved. The user can understand an item corresponding to the presentation video by watching the target sub-video that he or she wants to watch, such that the payment conversion efficiency of the item corresponding to the presentation video is improved.

For example, a slider is arranged in the progress control bar, and the drag operation on the progress control bar is a drag operation on the slider.

In some embodiments, using the progress control operation is a click operation as an example, the terminal, in response to the click operation on the progress control bar, displays, in the playback interface, a playback moment corresponding to an implementation position of the progress control operation on the progress control bar and a target image corresponding to the playback moment, such that a user accurately locates a playback moment that he or she needs to play back. Furthermore, because the server loads a plurality of segment topics corresponding to the target images in advance and highlights a segment topic of the target sub-video in which the target image is located, the response time of the playback interface is shortened and the user experience is improved.

In some embodiments, a plurality of segment topics are displayed in the target image, and the plurality of segment topics include other segment topics in addition to the segment topic of the segment to which the target image belongs (i.e., the segment topic of the target sub-video in which the target image is located). In the target image, the segment topic of the segment to which the target image belongs is highlighted.

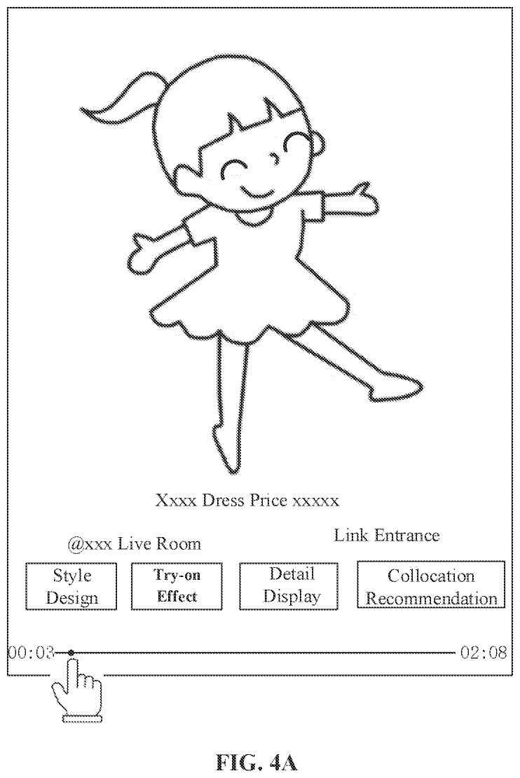

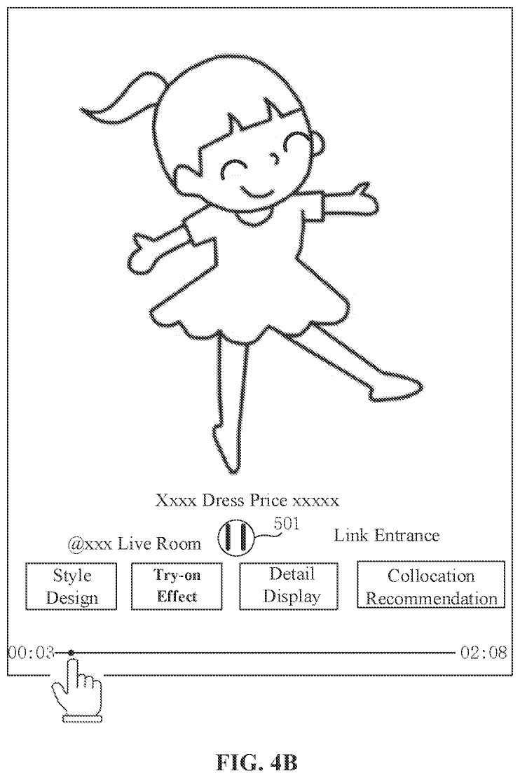

In some embodiments, as shown in FIG. 4A, four segment topics embedded in any one of the target images are displayed successively: style design, try-on effect, detail display, and collocation recommendation, and a segment topic. The segment topic of a target sub-video in which a target image belongs is “try on effect”, and the segment topic “try on effect” is highlighted (e.g., shown in bold fonts). In this way, the user directly notices the highlighted segment topic, determines content of the target sub-video in which the target image is located based on the highlighted segment topic, and then determines whether or not to play back the target sub-video. In addition, the target sub-video includes all the segments in the presentation video corresponding to the segment topic selected by the user. Therefore, the user is capable of finding all the segments with the same segment topic in the presentation video that he or she wants to watch, i.e., the target sub-video, by one search operation on the presentation video, without searching for the segments he or she wants to watch by jumping back and forth to search for the entire presentation video, such that the interaction efficiency of the user is improved. In some embodiments as illustrated in FIG. 4A, the target image also includes information about a live-streaming room (@xxx live-streaming room), a brief introduction such as “Xxxx Dress price: xxxx”, and a “link entrance.” As described below, in some embodiments, the information is embedded in the target sub-video.

In some embodiments, for a target sub-video, respective segment topics displayed in the target image of the target sub-video are displayed at different brightness, wherein the brightness of the segment topic corresponding to the target sub-video in which the target image is located is higher than the brightness of the segment topic corresponding to any other target sub-video. In this way, the user directly notices the segment topic of the target sub-video in which the target image is located, thereby quickly and accurately localizing the target sub-video that he or she wants to watch, such that the interaction efficiency of the user is improved.

In step 303, the terminal plays back a target sub-video corresponding to the segment topic in response to an operation on the segment topic.

The operation on the segment topic indicates the playback of the target sub-video corresponding to the segment topic, and the operation on the segment topic includes a click operation, a long press operation, a drag operation on the segment topic. That is, the displayed segment topic is configured as a control to trigger the display of the target sub-video.

In some embodiments, the terminal automatically plays back the target sub-video corresponding to the segment topic with a playback moment corresponding to the target image as a starting point in response to the operation on the segment topic, until the playback of the target sub-video ends. In this way, the user does not need to jump back and forth.

In some embodiments, the terminal automatically plays back the target sub-video corresponding to the segment topic with a playback moment corresponding to the target image as a starting point in response to the operation on the segment topic, and stops playing back the target sub-video in response to a click operation on the playback interface during the playback of the target sub-video. In some embodiments, in response to clicking on any point on the playback interface, the playback of the target sub-video is stopped, and in response to clicking on any point on the playback interface again, the playback of the target sub-video resumes. Alternatively, a close control corresponding to the target sub-video is displayed in the playback interface, and in response to clicking on the close control, the playback of the target sub-video is stopped and the playback of the presentation video resumes.

In some embodiments, the terminal plays back a plurality of consecutive segments in the target sub-video in response to the operation on a segment topic. The target sub-video is acquired by splicing the segments with the same segment topics. In playing back a target sub-video, the terminal successively plays back respective segments of the target sub-video in the playback interface in response to the operation on the segment topic, until the playback of the last segment in the target sub-video ends.

In some embodiments, the terminal, in response to the operation on the segment topic, successively plays back a plurality of segments associated with the segment topic. Playback moments of the plurality of segments being associated with the segment topic indicates that the plurality of segments have the segment topic and the plurality of segments form a target sub-video corresponding to the segment topic. For example, during the playback of the target sub-video, the terminal automatically jumps to another segment after completing the playback of a segment in the playback interface, and plays back another segment in the playback interface until the playback of all segments with the same segment topic in the target sub-video ends. Specifically, the terminal records playback moments of a plurality of segments associated with a segment topic. The playback moments include a start playback moment and an end playback moment of each segment. The terminal arranges the playback moments of the plurality of segments in the order from earliest to latest. Each time, the terminal extracts a group of start playback moments and end playback moments from the record, and then plays back the presentation video from the start playback moment to the end playback moment. In this way, the playback of one segment is completed. After that, the terminal extracts the next group of start and end playback moments from the record in sequence, and automatically jumps to the start playback moment extracted this time of the presentation video to play the next segment. In this way, the segments related to the segment topic is displayed and the segments not related to the segment topic are skipped. In this way, there is no need for the user to find out the segments that he or she wants to watch one by one from the entire presentation video, such that the interaction efficiency of the user is greatly improved. In addition, because the server loads the segments associated with the segment topics in advance, the response time of the server is reduced in the case that the terminal plays back the segments associated with the segment topics, such that the interaction efficiency of the user is improved.

Step 303 is for implementing the playback of the target sub-video. In some embodiments, the playback of the target sub-video is implemented in another way. For example, the terminal plays back the target sub-video in response to a playback operation on the target sub-video. In this way, the playback of the target sub-video is more flexible, and thus the user's satisfaction with watching the target sub-video is improved. The playback operation on the target sub-video is a click operation on the name of the target sub-video, or other operations. For example, the terminal plays back the presentation video in the playback interface and also displays the name of each target sub-video, and the target sub-video is played back in response to the click operation on the name of any of the target sub-videos. The name of the target sub-video is different from the segment topic. For example, the name of the target sub-video is a creative name named for the segment topic, or a name containing playback information of the target sub-video. The playback information includes the number of times that the target sub-video has been played back, the total playback duration, the number of segments included, and the like. That is, the target sub-video is identified by its name and displayed on the playback interface, and the name is configured as a control to trigger the display of the target sub-video. The target sub-video may also be identified by an image or a description on the content. Alternatively, the terminal displays a playback option for the target sub-video in the target image, and plays back the target sub-video in response to a trigger operation on the playback option.

In some embodiments, the presentation method for the presentation video further includes: playing back the presentation video with a playback moment at which playback of the target sub-video begins in the presentation video as a starting point in response to an ending of the playback of the target sub-video.

The terminal needs to resume the playback of the presentation video in response to the ending of the playback of the target sub-video. That is, the terminal continues the playback of the presentation video starting from the playback moment at which the playback of the target sub-video begins. For example, after a playback moment of the target image, or after a playback moment of the target image played back by the terminal in response to the progress control operation, the terminal plays back the target sub-video in response to an operation on the segment topic displayed in the target image. In this case, the terminal continues the playback of the presentation video with the playback moment of the target image as the starting point in response to the ending of the playback of the target sub-video.

In some embodiments, the presentation method for the presentation video further includes: stopping playing back of the target sub-video and playing back the presentation video with a playback moment at which playback of the target sub-video begins in the presentation video as a starting point in response to an operation to stop playing back the target sub-video.

For example, in the case that the operation to stop playing back the target sub-video is detected by the terminal during playback of the target sub-video (such as an operation of clicking on the target sub-video or on the segment topic, or an operation of clicking on a stop playback option) indicating that the user does not want to continue to watch the target sub-video, the terminal stops playing back the target sub-video, and resumes the playback of the presentation video. The terminal continues the playback of the presentation video starting from the playback moment at which the playback of the target sub-video begins. Referring to FIG. 4B, when the target sub-video corresponding to the segment topic “try-on effect” is played back, a stop playback option 501 is displayed, and the terminal stops the playback of the target sub-video when the user clicks the stop play option 501.

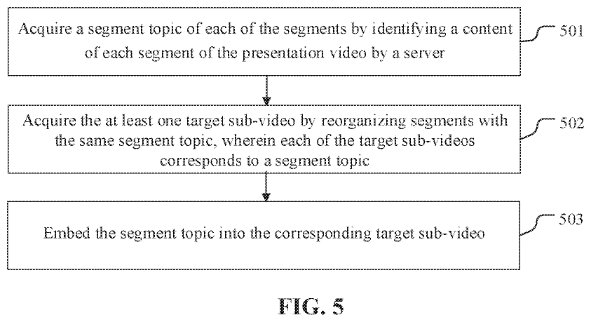

FIG. 5 is a schematic diagram of a flowchart of a method for identifying presentation videos according to some embodiments of the present disclosure. As shown in FIG. 5, the description of the embodiments of the present disclosure is given using a scenario where the method for identifying presentation videos is applicable to a server as an example. In some embodiment, the server is a server that provides an application run in a terminal such that a user can watch a presentation video provided by the live streaming platform. Applications may be social applications, live streaming applications, or resource interaction applications for examples. A user accesses a live streaming platform provided by the server through the applications to watch a presentation video on the live streaming platform. The method includes the following steps.

In step 501, a server acquires a segment topic of each of the segments by identifying content of each segment of the presentation video.

Identifying the content of the presentation video includes identifying at least one of the audio or the image of the presentation video. The content identification of the segment of the presentation video includes identifying at least one of the audio or the image of the segment of the presentation video. The segment topic acquired through the content identification indicates the content contained in the segment, and a user generally understands which perspective the content explained in the segment belongs to by browsing the segment topic.

The durations of the plurality of segments are the same or different, which is not limited herein. For example, the presentation video is sliced at every predetermined duration, and a plurality of segments are acquired. The duration of each of the segments other than the last segment in the presentation video equals the predetermined duration, and the duration of the last segment is less than or equal to the predetermined duration. Alternatively, the presentation video is sliced based on at least two highlight moments, and a plurality of segments are acquired. Each segment has a highlight moment as a starting point.

In some embodiments, the presentation video explains the item from a plurality of perspectives, and each perspective is viewed as a predetermined topic, then the presentation video includes segments belonging to each predetermined topic. In this way, when performing the content identification on the presentation video, a segment topic of each segment in the presentation video is determined from the plurality of predetermined topics. In some embodiments, the item is a garment, and the plurality of perspectives (i.e., the plurality of predetermined topics) include style design, try-on effect, detail display, collocation recommendation, and the like. In some embodiments, the item is a household appliance, and the plurality of perspectives (i.e., the plurality of predetermined topics) include functional introduction, instruction for use, detail display, and the like.

In step 502, the at least one target sub-video is acquired by reorganizing segments with the same segment topic, wherein each of the at least one target sub-video corresponds to a segment topic.

Any two segments with the same segment topic indicates that the content explained in the two segments is related or similar and may be played back together to the user, and thus the segments with the same segment topic are combined into the same target sub-video for subsequent playback of the segments with the same segment topic together.

In step 503, the segment topic is embedded into the corresponding target sub-video. Embedding the segment topic into the corresponding target sub-video includes embedding the segment topic into each frame of the target sub-video.

By embedding the segment topic into the corresponding target sub-video, the segment topic is displayed by any terminal during the playback of the presentation video, and the target sub-video corresponding to the segment topic is played back by performing an operation on the segment topic, that is, all the segments with the segment topic are played back successively.

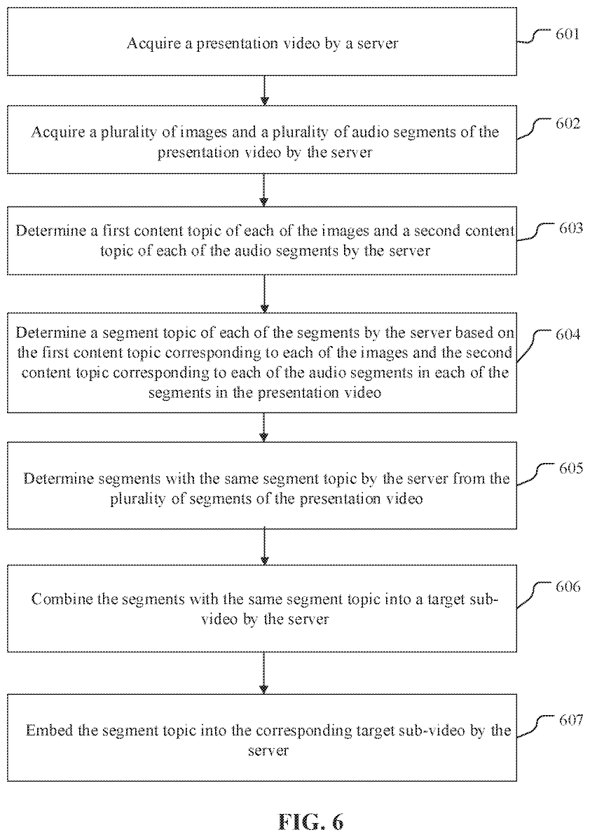

The embodiments shown in FIG. 5 are a brief flow of the embodiments of the present disclosure. FIG. 6 is a schematic diagram of an example flowchart of a method for identifying presentation videos according to some embodiments of the present disclosure. The technical solution of the present disclosure is further described hereinafter based on FIG. 6. The description of the embodiments of the present disclosure is given using a scenario where the method for identifying presentation videos is applicable to a server as an example. The method includes the following steps.

In step 601, a server acquires a presentation video.

The presentation video is a video that explains an item from a plurality of perspectives. The presentation video includes images for showing the item, and additionally includes audios for introducing the item.

In some embodiments, the server selects an image from the plurality of images in the presentation video as a cover image. The cover image includes an image of an item that is explained in the corresponding presentation video and a brief introduction of the item.

In some embodiments, the presentation video explains the item from a plurality of perspectives, and each of the perspectives is viewed as a predetermined topic, then the presentation video includes segments belonging to each of the predetermined topics. In this way, when the content identification is performed on the presentation video, a segment topic of each of the segments in the presentation video is determined from the plurality of predetermined topics.

In some embodiments, the item is a garment, and the plurality of perspectives include style design, try-on effect, detail display, collocation recommendation, and the like.

In some embodiments, the item is a household appliance, and the plurality of perspectives include function introduction, instruction for use, detail display, and the like. Based on different item types, different perspectives, such as specification, material, color, and brand, are included.

In some embodiments, the server acquires the presentation video by recording a live video stream in the live streaming process in response to a record request from the user for the live streaming process. In some embodiments, the server acquires the presentation video by receiving the presentation video uploaded by the terminal.

In some embodiments, the server recommends a plurality of presentation videos to the terminal in response to an access request from the user to a live streaming platform. For example, the server recommends the plurality of presentation videos to the terminal based on video data of each user to increase the satisfaction of the user with the video recommendation. The video data represents the video playback situation of the user, and is a historical video playback record of the user account or other data that represents the video playback situation of the user.

In step 602, the server acquires a plurality of images and a plurality of audio segments of the presentation video.

In some embodiments, the server acquires the plurality of images by analyzing frames of the presentation video. The server acquires an audio of the presentation video from the presentation video and slices the audio into the plurality of audio segments according to a predetermined segment duration, for example, the predetermined segment duration is 10 ms, 5 ms, or the like.

In some embodiments of the present disclosure, instead of first dividing the presentation video into a plurality of segments, the plurality of images and the plurality of audio segments in the presentation video are directly acquired, and subsequently, the presentation video is divided into a plurality of segments according to the content of the plurality of images and the plurality of audio segments, such that images and audio segments contained in each segment are determined. Alternatively, the presentation video is first divided into a plurality of segments, and images and audio segments in each segment are then acquired.

In step 603, the server determines a first content topic of each of the images, and a second content topic of each of the audio segments. The first content topic and the second content topic are determined separately.

In some embodiments, determining the first content topic of each of the images separately includes: identifying the content of each of the images by the server based on an image identification model and acquiring the first content topic of each of the images. For example, the server identifies the content of each of the images based on the image identification model, and determines the first content topic of each of the images from the plurality of predetermined topics.

The image identification model is acquired by training a large number of sample images. The training process includes: acquiring a plurality of sample images by the server, wherein each of the sample images corresponds to a content topic tag; training the image identification model based on the plurality of sample images and the content topic tag corresponding to each of the sample images; and acquiring the trained image identification model, wherein the content topic tags include a plurality of predetermined topic tags such as try-on effect, suitable scene, and style design.

In some embodiments, the training process of the image identification model further includes: acquiring sample images of different item types by the server, wherein one sample image or multiple sample images are acquired for each item type, and each of the sample images corresponds to a content topic tag; training the image identification model based on the sample images of the different item types and the content topic tags corresponding to the sample images; and acquiring the trained image identification model. The item type is, for example, a garment or a household appliance. In some embodiments of the present disclosure, the image identification model is trained based on the plurality of sample images of different item types, such that the image identification model is more targeted and has a higher degree of matching with the presentation video to be identified, and thus the identification accuracy of the image identification model is improved.

In some embodiments, determining the second content topic of each of the audio segments includes: performing content identification by the server on the plurality of audio segments based on an audio identification model and acquiring the second content topic of each of the audio segments in the plurality of audio segments. For example, the server performs the content identification on the plurality of audio segments based on the audio identification model and determines the second content topic of each of the audio segments from the plurality of predetermined topics.

The audio identification model is acquired by training a large number of sample audios. The training process includes: acquiring a plurality of sample audio segments by the server, wherein each of the sample audio segments corresponds to a content topic tag; training the audio identification model based on the plurality of sample audio segments and the content topic tag of each of the sample audio segments; and acquiring the trained audio identification model.

In some embodiments, the plurality of audio segments are acquired by extracting, every predetermined duration (e.g., 10 ms), one audio segment from the plurality of audio segments in the presentation video, and thus the number of audio segments that needs to be identified by the audio identification model is reduced. Afterward, the content identification is performed on the extracted plurality of audio segments based on the audio identification model, and the second content topic of each of the audio segments in the extracted plurality of audio segments is acquired. In this case, the number of audio segments that need to be identified by the audio identification model is reduced, and thus the identification rate of the audio identification model is improved when the content identification is performed on the extracted plurality of audio segments based on the audio identification model.

In step 604, the server determines a segment topic of each of the segments based on the first content topic corresponding to each of the images and the second content topic corresponding to each of the audio segments in each of the segments in the presentation video.

In some embodiments, step 604 includes the following. With respect to any one of the segments, a first target content topic of the segment is acquired. The first target content topic is a first content topic with the largest number in at least one first content topic of the segment, and the first content topic of the segment is a first content topic corresponding to an image in the segment. A second target content topic of the segment is acquired. The second target content topic is a second content topic with the largest number in at least one second content topic of the segment, and the second content topic of the segment is a second content topic corresponding to an audio segment in the segment. In the case where the first target content topic and the second target content topic are the same, a sum value is acquired by performing a weighted summation on the number of first target content topics and the number of second target content topics. In the case where the sum value satisfies a predetermined condition, the first target content topic is determined to be the segment topic of the segment. The predetermined condition may be some conditions such as being greater than a threshold value.

In some embodiments, a plurality of segments are acquired by slicing the presentation video every first predetermined duration. For example, in the case where the first predetermined duration is 1 min (minute), then the duration of each of the segments, except for the last segment in the presentation video, is 1 min, and the duration of the last segment is less than or equal to 1 min. Each of the segments includes a plurality of images and a plurality of audio segments. The plurality of audio segments are acquired by slicing the audio in each segment every second predetermined duration, and the second predetermined duration is less than the first predetermined duration. For example, in the case where the second predetermined duration is 0.2 s (seconds), the duration of each of the audio segments is 0.2 s except for the last audio segment in the segment, and the duration of the last audio segment is less than or equal to 0.2 s.

Using any one of the segments as an example, the various first content topics corresponding to the segment are determined, and the number of each first content topic are counted. For example, the total number of various first content topics corresponding to the segment is 80, wherein the number of first content topics of a first type is 10, the number of first content topics of a second type is 60, and the number of first content topics of a third type is 10. In this case, the first target content topic corresponding to the segment is the first content topic of the second type, and a percentage of the first target content topics is 60/80=0.75. The various second content topics corresponding to the segment are determined, and the number of each second content topic are counted. For example, the total number of various content topics corresponding to the segment is 50, wherein the number of second content topics of the first type is 5, the number of second content topics of the second type is 40, the number of second content topics of the third type is 5. In this case, the second target content topic corresponds to the segment is the second type of the second content topic, and a percentage of the second target content topic is 40/50=0.8. In the case where the first target content topic is “style design” and the second target content topic is “style design,” the second target content topic is the same as the first target content topic. For example, the proportion of the weight of the first target content topic is 0.6, and the proportion of the weight of the second target content topic is 0.4, then the sum value=0.6*0.75+0.4*0.8=0.77. In the case that the predetermined condition is that the sum value is greater than 0.6, the sum value of “0.77” satisfies the predetermined condition, and the first target content topic is determined as the segment topic of the segment. That is, the segment topic of the segment is “style design.”

In other embodiments, in the case where the first target content topic is different from the second target content topic, both the first target content topic and the second target content topic are determined as the segment topics of the segment; alternatively, any one of the first target content topic and the second target content topic is determined as the segment topic of the segment; alternatively, whether the number of the first target content topics and the number of the second target content topics satisfy a predetermined condition is determined, and in a case where the number of the first target content topics satisfies the predetermined condition, the first target content topic is determined as the segment topic of the segment, and alternatively, in a case where the number of the second target content topics satisfies the predetermined condition, the second target content topic is determined as the segment topic of the segment.

In step 605, the server determines segments with the same segment topic from the plurality of segments of the presentation video.

In step 606, the server combines the segments with the same segment topic into a target sub-video.

In some embodiments, the server acquires at least one segment with the same segment topic and acquires the target sub-video by splicing the at least one segment. In this way, when a user wants to watch a segment topic that he or she needs, the user is capable of directly locating a target sub-video corresponding to the segment topic, and there is no need to jump back and forth through the entire presentation video to locate all of the segments that the user wants to watch, such that the interaction efficiency of the user is improved. For example, the server acquires a plurality of segments corresponding to the segment topic “style design.” A first segment of the plurality of segments corresponds to a style design of an item of a first model, a second segment corresponds to a style design of an item of a second model, and a third segment corresponds to a style design of an item of a third model. The server acquires a target sub-video of the segment topic by splicing the first segment, the second segment, and the third segment. In this way, the user, when determining to play back the target sub-video based on the segment topic, may directly view the content of the style designs corresponding to all the items of different models in the entire presentation video successively, without respectively finding the style designs corresponding to the items of different models from different segments, and thus the efficiency of the user is improved.

The server splices segments with the same segment topic into a target sub-video, which is another video produced by the server, and the server separately stores the presentation video and the target sub-video. During the playback of the presentation video, if the target sub-video is triggered, such as clicking on the segment topic corresponding to the target sub-video, the terminal transmits a playback request for the target sub-video to the server. The server, in response to the playback request for the target sub-video, transmits the target sub-video to the terminal, and the target sub-video is played back by the terminal, and the playback of the presentation video is suspended at this time.

Step 606 is for acquiring a target sub-video, and in addition, alternatively, the target sub-video is acquired by the method below. Playback moments of segments with the same segment topic are associated with the segment topic, and thus the segments with the same segment topic are played back as one target sub-video.

In some embodiments, the server acquires at least one segment with the same segment topic, acquires playback moments of respective segments in the at least one segment, and associates the playback moments of respective segments with the same segment topic to indicate that the at least one segment associated with the same segment topic constitutes a target sub-video. In this way, when the user locates the target sub-video based on the segment topic, the user finds all the segments associated with the segment topic from the entire presentation video by one location operation, and thus the interaction efficiency of the user is improved. For example, the server acquires a plurality of segments corresponding to the segment topic “detail display.” A first segment of the plurality of segments corresponds to detail display content of an item in a first size, a second segment corresponds to detail display content of an item in a second size, and a third segment corresponds to detail display content of an item in a third size. The server acquires a playback moment of the first segment, a playback moment of the second segment, and a playback moment of the third segment, and associates the three playback moments with the segment topic “detail display.” In this way, in the case where the terminal plays back a target sub-video corresponding to the segment topic “detail display,” it automatically jumps to the second segment in response to an ending of playback of the first segment, and automatically jumps to the third segment in response to an ending of playback of the second segment, until the third segment ends, such that the response time of the server when the terminal plays back the various segments of the target sub-video is reduced, and thus the interaction efficiency of the user is improved.

For any video, the video includes a plurality of frames. Each frame has a corresponding playback moment, and the frames are played back successively based on the playback moments during the playback of the video. In a case where a progress control operation is detected when a first frame corresponding to a first playback moment is played back, if the progress control operation indicates jumping to a second playback moment for playback and the second playback moment is not a playback moment corresponding to the next frame of the first frame, a second frame corresponding to the second playback moment is then extracted from the video directly, and the second frame and frames following the second frame are played back, and frames after the first frame and before the second frame are not played back. In some embodiments of the present disclosure, the same segment topic is associated with playback moments of a plurality of segments in the presentation video, and the playback moments of each segment include a start playback moment and an end playback moment. In this way, in accordance with the order of the playback moments of the plurality of segments, each time the, terminal begins the playback of a segment from a frame corresponding to a start playback moment of the segment to a frame corresponding to an end playback moment of the segment, thereafter, the terminal jumps to a start playback moment of the next segment, such that the jump of playback is achieved.

In the case of associating playback moments of a segment with a segment topic of the segment, the server does not need to produce a separate target sub-video. The server stores the playback moments associated with the segment topic, then the server determines which segments belong to a target sub-video corresponding to the segment topic based on the playback moments associated with the segment topic. If a target sub-video is triggered during the playback of the presentation video, such as clicking on a segment topic corresponding to the target sub-video, the terminal transmits a playback request to the server, and the playback request carries the segment topic. Then, the server determines playback moments associated with the segment topic and transmits segments corresponding to the playback moments to the terminal, which will be played back by the terminal. The terminal plays back the segments associated with the segment topic successively, and thus the playback of the target sub-video is achieved.

In some embodiments, the server records playback moments of a plurality of segments associated with a segment topic. The playback moments include a start playback moment and an end playback moment of each segment. The server arranges the playback moments of the plurality of segments in the order from earliest to latest. Each time, the server extracts a group of start playback moments and end playback moments from the record and transmits the group to the terminal. Then, the terminal plays back the presentation video from the start playback moment to the end playback moment. In this way, the playback of one segment is completed. After that, the terminal transmits a jump request to the server, and the server, in response to the jump request, extracts the next group of start and end playback moments from the record in sequence and transmits the next group to the terminal. Then, the terminal automatically jumps to the start playback moment of the next group in the presentation video and plays back the presentation video from the start playback moment of the next group to the end playback moment of the next group. In this way, the playback of the next segment is completed.

Step 605 to step 606 are implementations of step 502.

In step 607, the server embeds the segment topic into the corresponding target sub-video.

In some embodiments, the target sub-video includes a plurality of images, and the server acquires a plurality of images to-be-previewed of the target sub-video by embedding the segment topic into the respective images in the corresponding target sub-video.

In some embodiments, the server acquires a plurality of images to-be-previewed of the presentation video by respectively embedding the plurality of segment topics into the images in the presentation video corresponding to the plurality of segment topics, wherein the image to-be-previewed highlights the segment topic of the target sub-video where this image is located.

In some embodiments of the present disclosure, when any one of the images to-be-previewed is displayed to a user, the segment topic is highlighted in the to-be-previewed image. Thus, the user can be quickly informed of a topic of content of the to-be-previewed image, which allows the user to play back the target sub-video corresponding to the segment topic by performing an operation on the segment topic. That is, the user can accurately locate the target sub-video without performing jump back and forth and other operations to locate the target sub-video that he or she wants to watch, and thus the efficiency of human-computer interaction is greatly improved.

In some embodiments, the presentation video includes a plurality of segments. After a plurality of segment topics of the segments are determined, the plurality of segment topics are respectively embedded into images in a target sub-video corresponding to the plurality of segment topics in the presentation video.

In some embodiments, the server acquires information of a live streaming room of the presentation video, and embeds the information of the live streaming room into respective images of the presentation video. The information about the live streaming room includes the name of the live streaming room to increase the attention of a user to the live streaming room, such that the payment conversion efficiency of the user in the live streaming room is improved.

In some embodiments, the server acquires a brief introduction of the presentation video, and embeds the brief introduction into respective images of the presentation video. The brief introduction includes information on an item corresponding to the presentation video such as the price and name. In this way, it is convenient for a user to intuitively understand general content of the presentation video through the brief introduction.

In some embodiments, the server embeds at least one entrance to a link into each image of the presentation video. The entrance to the link includes an entrance to an activity link and an entrance to a feedback link. In this way, it is convenient for a user to quickly access the corresponding link through the entrance to the link.

In some embodiments, embedding the segment topic into the respective images of the corresponding target sub-video and acquiring the plurality of images to-be-previewed of the target sub-video by the server includes the following steps.

The server embeds the segment topic into each of the images in the corresponding target sub-video, acquires at least one of the brief introduction or the link entrance of the target sub-video, embeds the at least one of the brief introduction or the link entrance of the target sub-video into each of the images of the target sub-video, and acquires the plurality of to-be-previewed images of the target sub-video. In this way, upon displaying any one of the to-be-previewed images to a user, the segment topic, the brief introduction, and the link entrance are displayed in the to-be-previewed image, and thus the user can play back the target sub-video by performing an operation on the segment topic, view the brief introduction of the target sub-video, or quickly access the corresponding link through the link entrance.

In some embodiments, the display form of the plurality of segment topics is changed based on the design and may be in any form.

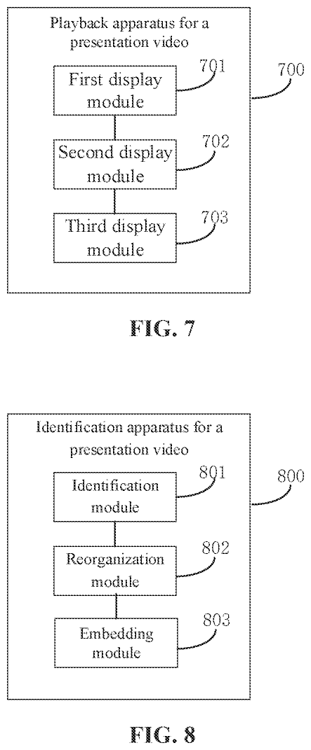

FIG. 7 is a schematic structural diagram of a playback apparatus for a presentation video according to some embodiments of the present disclosure. The apparatus includes a first display module 701, configured to display a playback interface for a presentation video in response to a trigger operation on the presentation video; a second display module 702, configured to display a segment topic in the playback interface, wherein the segment topic is determined based on content identification of a segment of the presentation video; and a third display module 703, configured to play back a target sub-video corresponding to the segment topic in response to an operation on the segment topic, wherein the target sub-video includes segments with the same segment topic.

In some embodiments, this second display module 702 is configured to display, in an image currently played back in the playback interface, a segment topic of a segment to which the image belongs; or play back a segment corresponding to a progress control operation in the playback interface and display a segment topic of the segment in response to the progress control operation on the playback interface.

In some embodiments, the second display module 702 includes a display unit, configured to display a target image in the playback interface in response to the progress control operation on the playback interface, wherein the segment topic is displayed in the target image, and a playback moment of the target image corresponds to a playback moment indicated by the progress control operation.

In some embodiments, the third display module 703 is configured to play back a target sub-video corresponding to the segment topic with the playback moment of the target image as a starting point in response to an operation on the segment topic.

In some embodiments, the third display module 703 is further configured to play back the presentation video with a playback moment at which playback of the target sub-video begins in the presentation video as a starting point in response to an ending of the playback of the target sub-video; or the third display module 703 is further configured to stop playing back the target sub-video and play back the presentation video with a playback moment at which the playback of the target sub-video begins in the presentation video as a starting point in response to an operation to stop playing back the target sub-video.

In some embodiments, the third display module 703 is configured to successively play back a plurality of segments associated with the segment topic in response to an operation on the segment topic, wherein the segment being associated with the segment topic indicates that the segment has the segment topic.

In some embodiments, the apparatus further includes a playback module, configured to play back the target sub-video in response to a playback operation on the target sub-video.

It should be noted that description is only given to the division of the functional modules for the method for playing back presentation videos according to the above embodiments. In practice, the functions of the apparatus may be assigned to and implemented by different functional modules according to actual needs. That is, in terms of internal structure, the apparatus is divided into different functional modules to implement a part or all of the functions as described above. In addition, the playback apparatus for the presentation according to the above embodiments is based on the same concept as the method embodiments as described above, and the specific implementation process of the apparatus is detailed in the method embodiments, which is not repeated herein.

FIG. 8 is a schematic structural diagram of an identification apparatus for a presentation video according to some embodiments of the present disclosure. The apparatus includes an identification module 801, configured to acquire a segment topic of each segment by performing content identification on each segment in the presentation video; a reorganization module 802, configured to acquire at least one target sub-video by reorganizing segments with the same segment topic, wherein each of the at least one target sub-video corresponds to one segment topic; and an embedding module 803, configured to embed the segment topic into the corresponding target sub-video.

In some embodiments, the identification module 801 includes: an acquisition unit, configured to acquire a plurality of images and a plurality of audio segments of the presentation video; a first determination unit, configured to determine a first content topic of each of the images and a second content topic of each of the audio segments; and a second determination unit, configured to determine a segment topic of each of the segments based on the first content topic and the second content topic that correspond to each of the segments in the presentation video.

In some embodiments, the second determination unit includes: a first acquisition subunit, configured to acquire, with respect to any of the segments, a first target content topic of the segment, wherein the first target content topic is a first content topic with the largest number in at least one of the first content topics of the segment; a second acquisition subunit, configured to acquire a second target content topic of the segment, wherein the second target content topic is a second content topic with the largest number in at least one of the second content topics of the segment; a calculation subunit, configured to acquire a sum value by performing a weighted summation on the number of first target content topics and the number of second target content topics in response to the first target content topic being the same as the second target content topic; and a determination subunit, configured to determine the first target content topic as the segment topic of the segment in response to the sum value satisfying a predetermined condition.

In some embodiments, the reorganization module 802 includes: a determination unit, configured to determine, from a plurality of segments of the presentation video, segments with the same segment topic; and a combination unit, configured to play back the segments with the same segment topic as a target sub-video by combing the segments with the same segment topic into a target sub-video or associating playback moments of the segments with the same segment topic with the segment topic.

In some embodiments, the embedding module 803 includes an embedding unit, configured to acquire a plurality of to-be-previewed images of the target sub-video by embedding the segment topic into corresponding respective images in the target sub-video.

In some embodiments, the embedding unit is configured to embed the segment topic into the corresponding respective images in the target sub-video; and acquire the plurality of to-be-previewed images of the target sub-video by acquiring at least one of a brief introduction and a link entrance of the target sub-video and embedding at least one of the brief introduction or the link entrance of the target sub-video into the respective image in the target sub-video.

It should be noted that description is only given to the division of the functional modules for the method for identifying presentation videos according to the above embodiments. In practice, the functions of the apparatus may be assigned to and implemented by different functional modules according to actual needs. That is, in terms of internal structure, the apparatus is divided into different functional modules to implement a part or all of the functions as described above. In addition, the identification apparatus for the presentation according to the above embodiments is based on the same concept as the method embodiments as described above, and the specific implementation process of the apparatus is detailed in the method embodiments, which is not repeated herein.

Some embodiments of the present disclosure further provide a computer device. The computer device includes a processor and a memory. The memory stores at least one program therein. The at least one program, when loaded and run by the processor of the computer device, causes the computer device to display a playback interface for a presentation video in response to a trigger operation on the presentation video; display a segment topic in the playback interface, wherein the segment topic is determined based on content identification of a segment in the presentation video; and play back a target sub-video corresponding to the segment topic in response to an operation on the segment topic, wherein the target sub-video includes segments with the same segment topic.

In some embodiments, the at least one program, when loaded and run by the processor of the computer device, causes the computer device to display, in an image currently played back in the playback interface, a segment topic of a segment to which the image belongs; or play back a segment corresponding to a progress control operation in the playback interface and display a segment topic of the segment in response to the progress control operation on the playback interface.

In some embodiments, the at least one program, when loaded and run by the processor of the computer device, causes the computer device to display a target image in the playback interface in response to a progress control operation on the playback interface, wherein the segment topic is displayed in the target image and a playback moment of the target image corresponds to a playback moment indicated by the progress control operation.

In some embodiments, the at least one program, when loaded and run by the processor of the computer device, causes the computer device to play back a target sub-video corresponding to the segment topic with a playback moment of the target image as a starting point in response to an operation on the segment topic.

In some embodiments, the at least one program, when loaded and run by the processor of the computer device, causes the computer device to play back the presentation video with the playback moment at which playback of the target sub-video begins in the presentation video as a starting point in response to an ending of the playback of the target sub-video; or stop playing back the target sub-video and play back the presentation video with a playback moment at which playback of the target sub-video begins in the presentation video as a starting point in response to an operation to stop playing back the target sub-video.

In some embodiments, the at least one program, when loaded and run by the processor of the computer device, causes the computer device to successively play back a plurality of segments associated with the segment topic in response to an operation on the segment topic; wherein the segment being associated with the segment topic indicates that the segment has the segment topic.

In some embodiments, the at least one program, when loaded and run by the processor of the computer device, causes the computer device to play back the target sub-video in response to a playback operation on the target sub-video.

Some embodiments of the present disclosure further provide a computer device. The computer device includes a processor and a memory. The memory stores at least one program therein. The at least one program, when loaded and run by the processor of the computer device, causes the computer device to acquire segment topics of respective segments by performing content identification on the respective segments in a presentation video; acquire at least one target sub-video by reorganizing the segments with the same segment topic, wherein each of the at least one target sub-video corresponds to one segment topic; and embed the segment topic into the corresponding target sub-video.

In some embodiments, the at least one program, when loaded and run by the processor of the computer device, causes the computer device to acquire a plurality of images and a plurality of audio segments of the presentation video; determine a first content topic of each of the images and a second content topic of each of the audio segments; and determine a segment topic of each of the segments based on the first content topic and the second content topic that correspond to each of the segments in the presentation video.

In some embodiments, the at least one program, when loaded and run by the processor of the computer device, causes the computer device to acquire, with respect to any one of the segments, a first target content topic of the segment, wherein the first target content topic is a first content topic with the largest number in at least one of the first content topics of the segment; acquire a second target content topic of the segment, wherein the second target content topic is a second content topic with the largest number in at least one of the second content topics of the segment; acquire a sum value by performing a weighted summation on the number of first target content topics and the number of second target content topics in response to the first target content topic being the same as the second target content topic; and determine the first target content topic as a segment topic of the segment in response to the sum value satisfying a predetermined condition.

In some embodiments, the at least one program, when loaded and run by the processor of the computer device, causes the computer device to determine, from a plurality of segments of the presentation video, segments with the same segment topic; and play back the segments with the same segment topic as a target sub-video by combining the segments with the same segment topic into the target sub-video or associating playback moments of the segments with the same segment topic with the segment topic matter.

In some embodiments, the at least one program, when loaded and run by the processor of the computer device, causes the computer device to acquire a plurality of to-be-previewed images of the target sub-video by embedding the segment topic into corresponding respective images in the target sub-video.

In some embodiments, the at least one program, when loaded and run by the processor of the computer device, causes the computer device to embed the segment topic into the corresponding respective images in the target sub-video; and acquire the plurality of to-be-previewed images of the target sub-video by acquiring at least one of a brief introduction and a link entrance of the target sub-video and embedding at least one of the brief introduction or the link entrance of the target sub-video into the respective image in the target sub-video.

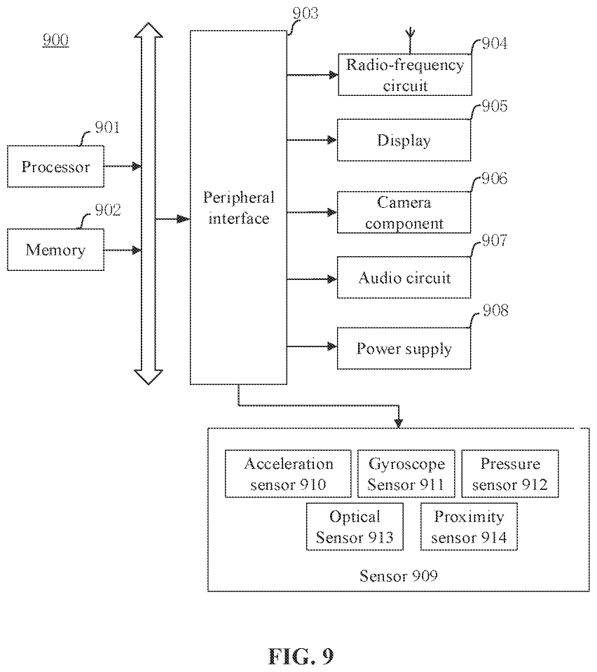

The description is given using a scenario where the computer device is the terminal as an example. FIG. 9 is a structural block diagram of a terminal according to some embodiments of the present disclosure. As illustrated in FIG. 9, the terminal 900 is a smartphone, a tablet computer, a moving image experts group audio layer III (MP3) player, a moving image experts group audio layer IV (MP4) player, or a laptop or desktop computer. The terminal 900 is also referred to as a user device, a portable terminal, a laptop terminal, a desktop terminal, and the like.

Typically, the terminal 900 includes a processor 901 and a memory 902.

The processor 901 includes one or more processing cores, such as a 4-core processor or an 8-core processor. The processor 901 is implemented using a hardware form of at least one of a digital signal processor (DSP), a field-programmable gate array (FPGA), and a programmable logic array (PLA). The processor 901 also includes a main processor and a co-processor. The main processor is a processor, also referred to as a central processing unit (CPU), for processing data in a wake-up state; and the co-processor is a low-power processor for processing data in a standby state. In some embodiments, the processor 901 is integrated with a graphics processing unit (GPU). The GPU is used to render and draw the content to be displayed by the display. In some embodiments, the processor 901 also includes an Artificial Intelligence (AI) processor that is used to handle computational operations related to machine learning.

The memory 902 includes one or more computer-readable storage media, which in some embodiments are non-transitory. In some embodiments, the memory 902 further includes a high-speed random access memory and a non-volatile memory, such as one or more disk storage devices and flash memory storage devices. In some embodiments, the non-transitory computer-readable storage medium in the memory 902 is configured to store at least one program code. The at least one program code, when loaded and run by the processor 901 of the terminal 900, causes the terminal 900 to perform the method for playing back presentation videos or the method for identifying presentation videos according to the method embodiments of the present disclosure.

In some embodiments, the terminal 900 further optionally includes a peripheral device interface 903 and at least one peripheral device. The processor 901, the memory 902, and the peripheral device interface 903 are connected to each other by a bus or signal lines. Each peripheral device is connected to the peripheral device interface 903 by a bus, a signal line, or a circuit board. Schematically, the peripheral devices include at least one of a radio frequency circuit 904, a display screen 905, a camera component 906, an audio circuit 907, and a power supply 908.

The peripheral device interface 903 is configured to connect at least one peripheral device related to an input/output (I/O) to the processor 901 and the memory 902. In some embodiments, the processor 901, the memory 902, and the peripheral device interface 903 are integrated into the same chip or board, and in some other embodiments, either or both of the processor 901, the memory 902, and the peripheral device interface 903 may be implemented on a separate chip or board, which are not limited herein.

The radio frequency circuit 904 is configured to receive and transmit radio frequency (RF) signals, also known as electromagnetic signals. The radio frequency circuit 904 communicates with communication networks and other communication devices over the electromagnetic signals. The radio frequency circuit 904 converts electrical signals to electromagnetic signals for transmission, or converts received electromagnetic signals to electrical signals. In some embodiments, the radio frequency circuit 904 includes an antenna system, a radio frequency transceiver, one or more amplifiers, a tuner, an oscillator, a digital signal processor, a codec chipset, a user identity module card, and the like. The radio frequency circuit 904 communicates with other terminals by at least one wireless communication protocol. The wireless communication protocols include, but are not limited to metropolitan area networks, various generations of mobile communication networks (2G, 3G, 4G, and 5G), wireless local area networks, and/or wireless fidelity (Wi-Fi) networks. In some embodiments, the radio frequency circuit 904 further includes a near field communication (NFC) related circuit, which is not limited herein.

The display screen 905 is configured to display a user interface (UI). The UI includes graphics, text, icons, video, and any combination thereof. In the case that the display screen 905 is a touch display, the display screen 905 further has the ability to capture a touch signal at or above a surface of the display screen 905. This touch signal is input to the processor 901 as a control signal for processing. At this point, the display screen 905 is further configured to provide a virtual button and/or a virtual keyboard, also referred to as a soft button and/or a soft keyboard. In some embodiments, the display screen 905 is a front panel arranged on the terminal 900; in other embodiments, there are at least two display screens 905, arranged on different surfaces of the terminal 900 or in a folded design; and in other embodiments, the display screen 905 is a flexible display, arranged on a curved surface or a folded surface of the terminal 900. Even more, the display screen 905 is arranged in a non-rectangular irregular shape, i.e., a shaped screen. The display screen 905 is prepared using materials such as a liquid crystal display (LCD), an organic light-emitting diode (OLED), and the like.

The camera component 906 is configured to capture images or videos. In some embodiments, the camera component 906 includes a front camera and a rear camera. Typically, the front camera is arranged on the front panel of the terminal and the rear camera is arranged on the back of the terminal. In some embodiments, there are at least two rear cameras, each of which is any one of a main camera, a depth-of-field camera, a wide-angle camera, and a telephoto camera, to achieve a background defocusing function by the fusion of the main camera and the depth-of-field camera, a panoramic or virtual reality (VR) shooting function by the fusion of the main camera and the wide-angle camera, or other fusion shooting functions. In some embodiments, the camera component 906 further includes a flash. The flash is a single-color temperature flash or a dual-color temperature flash. The dual color temperature flash is a combination of a warm light flash and a cool light flash and is configured for light compensation at different color temperatures.

The audio circuit 907 includes a microphone and a loudspeaker. The microphone is configured to capture sound waves from a user and an environment, convert the sound waves into electrical signals, and input the electrical signals to the processor 901 for processing or to the radio frequency circuit 904 for voice communication. For stereo sound recording or noise reduction, there are a plurality of microphones, which are arranged at different parts of the terminal 900. In some embodiments, the microphones are array microphones or omnidirectional capture-type microphones. The loudspeaker is configured to convert the electrical signals from the processor 901 or the radio frequency circuit 904 into sound waves. The loudspeaker is a conventional thin film loudspeaker or a piezoelectric ceramic loudspeaker. In the case that the loudspeaker is a piezoelectric ceramic loudspeaker, it is possible to convert the electrical signals to sound waves that are audible to humans and convert the electrical signals to sound waves that are inaudible to humans for purposes of ranging. In some embodiments, the audio circuit 907 further includes a headphone jack.

The power supply 908 is configured to power various components in the terminal 900. The power supply 908 is an alternating current, a direct current, a disposable battery, or a rechargeable battery. Where the power supply 908 includes the rechargeable battery, the rechargeable battery supports wired charging or wireless charging. The rechargeable battery further supports the fast charging technology.

In some embodiments, the terminal 900 further includes one or more sensors 909. The one or more sensors 909 include, but are not limited to an acceleration sensor 910, a gyroscope sensor 911, a pressure sensor 912, an optical sensor 913, and a proximity sensor 914.

The acceleration sensor 910 detects the magnitude of acceleration on three coordinate axes of a coordinate system established by the terminal 900. For example, the acceleration sensor 910 is configured to detect components of acceleration of gravity on the three coordinate axes. The processor 901 controls the display 905 to display the user interface in a horizontal view or a longitudinal view based on gravitational acceleration signals collected by the acceleration sensor 910. The acceleration sensor 910 is further configured to collect motion data of games or users.

The gyroscope sensor 911 detects a body direction and rotation angle of the terminal 900. The gyroscope sensor 911 collects 3D motions by the user to the terminal 900 collaborating with the acceleration sensor 910. The processor 901, based on the data collected by the gyroscope sensor 911, implements the following functions: motion sensing (e.g., changing the UI based on the user's tilt operation), image stabilization during shooting, game control, and inertial navigation.

The pressure sensor 912 is arranged on a side bezel of the terminal 900 and/or a lower layer of the display 905. In the case that the pressure sensor 912 is arranged on the side bezel of the terminal 900, a grip signal from a user to the terminal 900 is detected, and the processor 901 performs a identification of right and left hands or a shortcut operation based on the grip signal collected by the pressure sensor 912. In the case that the pressure sensor 912 is arranged in the lower layer of the display 905, the processor 901 controls an operable control on the UI page according to a pressure operation of the user on the display 905. The operable control includes at least one of a button control, a scroll bar control, an icon control, and a menu control.

The optical sensor 913 is configured to capture ambient light intensity. In some embodiments, the processor 901 controls the display brightness of the display 905 based on the ambient light intensity captured by the optical sensor 913. Schematically, the display brightness of the display 905 is turned up in case of high ambient light intensity, and the display brightness of the display 905 is turned down in case of low ambient light intensity. In some other embodiments, the processor 901 dynamically adjusts the shooting parameters of the camera component 906 based on the ambient light intensity captured by the optical sensor 913.

The proximity sensor 914, also referred to as a distance sensor, is typically arranged on the front panel of the terminal 900. The proximity sensor 914 is configured to capture a distance between a user and the front of the terminal 900. In some embodiments, in the case that the proximity sensor 914 detects that the distance between the user and the front of the terminal 900 gradually becomes smaller, the display 905 is controlled by the processor 901 to switch from a bright screen state to a lock screen state; and in the case that the proximity sensor 914 detects that the distance between the user and the front of the terminal 900 gradually becomes larger, the processor 901 controls the display 905 to switch from the lock screen state to the bright screen state.

It should be understood by those skilled in the art that the structure illustrated in FIG. 9 does not constitute any limitation to the terminal 900, and in some embodiments, the terminal 900 includes more or fewer components than illustrated or a combination thereof or employs different arrangements of components.

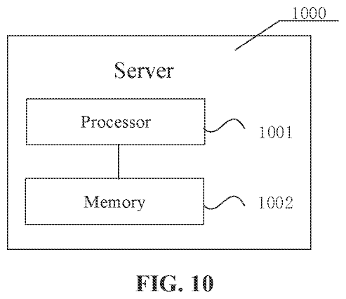

The description is given using a scenario where the computer device is the server as an example. FIG. 10 is a schematic structural diagram of a server according to some embodiments of the present disclosure. The server 1000, which varies widely depending on the configuration or performance, includes one or more processors (central processing units, CPUs) 1001 and one or more memories 1002. The one or more memories 1002 store at least one computer program therein. The at least one computer program, when loaded and run by the one or more processors 1001 of the server, causes the server to perform the method for playing back presentation videos or the method for identifying presentation videos described above. The server 1000 also includes components such as a wired or wireless network interface, a keyboard, and an input/output interface for input/output, and the server 1000 includes other components for achieving functions of the device, which are not repeated herein.

According to some embodiments of the present disclosure, a non-transitory computer-readable storage medium, storing one or more computer programs therein, is provided. The one or more computer programs, when loaded and run by the non-transitory computer-readable storage medium of a device, cause the device to perform the method for playing back presentation videos or the method for identifying presentation videos described above. In some embodiments, the non-transitory computer-readable storage medium is a read-only memory (ROM), a random access memory (RAM), a compact-disc read-only memory (CD-ROM), a magnetic tape, a floppy disk, or an optical data storage device.

Some embodiments of the present disclosure further provide a non-transitory computer-readable storage medium. The non-transitory computer-readable storage medium stores at least one program therein. The at least one program, when loaded and run by a processor, causes the processor to display a playback interface for a presentation video in response to a trigger operation on the presentation video; display a segment topic in the playback interface, wherein the segment topic is determined based on content identification of a segment in the presentation video; and play back a target sub-video corresponding to the segment topic in response to an operation on the segment topic, wherein the target sub-video includes segments with the same segment topic.

In some embodiments, the at least one program, when loaded and run by a processor, causes the processor to display, in an image currently played back in the playback interface, a segment topic of a segment to which the image belongs; or play back a segment corresponding to a progress control operation in the playback interface and display a segment topic of the segment in response to the progress control operation on the playback interface.

In some embodiments, the at least one program, when loaded and run by a processor, causes the processor to display a target image in the playback interface in response to a progress control operation on the playback interface, wherein the segment topic is displayed in the target image and a playback moment of the target image corresponds to a playback moment indicated by the progress control operation.

In some embodiments, the at least one program, when loaded and run by a processor, causes the processor to play back a target sub-video corresponding to the segment topic with a playback moment of the target image as a starting point in response to an operation on the segment topic.

In some embodiments, the at least one program, when loaded and run by a processor, causes the processor to play back the presentation video with the playback moment at which playback of the target sub-video begins in the presentation video as a starting point in response to an ending of the playback of the target sub-video; or stop playing back the target sub-video and play back the presentation video with a playback moment at which playback of the target sub-video begins in the presentation video as a starting point in response to an operation to stop playing back the target sub-video.

In some embodiments, the at least one program, when loaded and run by a processor, causes the processor to successively play back a plurality of segments associated with the segment topic in response to an operation on the segment topic; wherein the segment being associated with the segment topic indicates that the segment has the segment topic.

In some embodiments, the at least one program, when loaded and run by a processor, causes the processor to play back the target sub-video in response to a playback operation on the target sub-video.

Some embodiments of the present disclosure further provide a non-transitory computer-readable storage medium. The non-transitory computer-readable storage medium stores at least one program therein. The at least one program, when loaded and run by a processor, causes the processor to acquire segment topics of respective segments by performing content identification on the respective segments in a presentation video; acquire at least one target sub-video by reorganizing the segments with the same segment topic, wherein each of the at least one target sub-video corresponds to one segment topic; and embed the segment topic into the corresponding target sub-video.

In some embodiments, the at least one program, when loaded and run by a processor, causes the processor to acquire a plurality of images and a plurality of audio segments of the presentation video; determine a first content topic of each of the images and a second content topic of each of the audio segments; and determine a segment topic of each of the segments based on the first content topic and the second content topic that correspond to each of the segments in the presentation video.

In some embodiments, the at least one program, when loaded and run by a processor, causes the processor to acquire, with respect to any one of the segments, a first target content topic of the segment, wherein the first target content topic is a first content topic with the largest number in at least one of the first content topics of the segment; acquire a second target content topic of the segment, wherein the second target content topic is a second content topic with the largest number in at least one of the second content topics of the segment; acquire a sum value by performing a weighted summation on the number of first target content topics and the number of second target content topics in response to the first target content topic being the same as the second target content topic; and determine the first target content topic as a segment topic of the segment in response to the sum value satisfying a predetermined condition.

In some embodiments, the at least one program, when loaded and run by a processor, causes the processor to determine, from a plurality of segments of the presentation video, segments with the same segment topic; and play back the segments with the same segment topic as a target sub-video by combining the segments with the same segment topic into the target sub-video or associating playback moments of the segments with the same segment topic with the segment topic matter.

In some embodiments, the a at least one program, when loaded and run by a processor, causes the processor to acquire a plurality of to-be-previewed images of the target sub-video by embedding the segment topic into corresponding respective images in the target sub-video.

In some embodiments, the at least one program, when loaded and run by a processor, causes the processor to embed the segment topic into the corresponding respective images in the target sub-video; and acquire the plurality of to-be-previewed images of the target sub-video by acquiring at least one of a brief introduction and a link entrance of the target sub-video and embedding at least one of the brief introduction or the link entrance of the target sub-video into the respective image in the target sub-video.

Some embodiments of the present disclosure further provide a computer program product. The computer program product includes at least one program therein. The at least one program, when loaded and run by a processor, causes the processor to display a playback interface for a presentation video in response to a trigger operation on the presentation video; display a segment topic in the playback interface, wherein the segment topic is determined based on content identification of a segment in the presentation video; and play back a target sub-video corresponding to the segment topic in response to an operation on the segment topic, wherein the target sub-video includes segments with the same segment topic.

In some embodiments, the at least one program, when loaded and run by a processor, causes the processor to display, in an image currently played back in the playback interface, a segment topic of a segment to which the image belongs; or play back a segment corresponding to a progress control operation in the playback interface and display a segment topic of the segment in response to the progress control operation on the playback interface.

In some embodiments, the at least one program, when loaded and run by a processor, causes the processor to display a target image in the playback interface in response to a progress control operation on the playback interface, wherein the segment topic is displayed in the target image and a playback moment of the target image corresponds to a playback moment indicated by the progress control operation.

In some embodiments, the at least one program, when loaded and run by a processor, causes the processor to play back a target sub-video corresponding to the segment topic with a playback moment of the target image as a starting point in response to an operation on the segment topic.

In some embodiments, the at least one program, when loaded and run by a processor, causes the processor to play back the presentation video with the playback moment at which playback of the target sub-video begins in the presentation video as a starting point in response to an ending of the playback of the target sub-video; or stop playing back the target sub-video and play back the presentation video with a playback moment at which playback of the target sub-video begins in the presentation video as a starting point in response to an operation to stop playing back the target sub-video.

In some embodiments, the at least one program, when loaded and run by a processor, causes the processor to successively play back a plurality of segments associated with the segment topic in response to an operation on the segment topic; wherein the segment being associated with the segment topic indicates that the segment has the segment topic.

In some embodiments, the at least one program, when loaded and run by a processor, causes the processor to play back the target sub-video in response to a playback operation on the target sub-video.

Some embodiments of the present disclosure also provide a computer program product. The computer program product includes at least one program therein. The at least one program, when loaded and run by a processor, causes the processor to acquire segment topics of respective segments by performing content identification on the respective segments in a presentation video; acquire at least one target sub-video by reorganizing the segments with the same segment topic, wherein each of the at least one target sub-video corresponds to one segment topic; and embed the segment topic into the corresponding target sub-video.

In some embodiments, the at least one program, when loaded and run by a processor, causes the processor to acquire a plurality of images and a plurality of audio segments of the presentation video; determine a first content topic of each of the images and a second content topic of each of the audio segments; and determine a segment topic of each of the segments based on the first content topic and the second content topic that correspond to each of the segments in the presentation video.

In some embodiments, the at least one program, when loaded and run by a processor, causes the processor to acquire, with respect to any one of the segments, a first target content topic of the segment, wherein the first target content topic is a first content topic with the largest number in at least one of the first content topics of the segment; acquire a second target content topic of the segment, wherein the second target content topic is a second content topic with the largest number in at least one of the second content topics of the segment; acquire a sum value by performing a weighted summation on the number of first target content topics and the number of second target content topics in response to the first target content topic being the same as the second target content topic; and determine the first target content topic as a segment topic of the segment in response to the sum value satisfying a predetermined condition.

In some embodiments, the at least one program, when loaded and run by a processor, causes the processor to determine, from a plurality of segments of the presentation video, segments with the same segment topic; and play back the segments with the same segment topic as a target sub-video by combining the segments with the same segment topic into the target sub-video or associating playback moments of the segments with the same segment topic with the segment topic matter.

In some embodiments, the a at least one program, when loaded and run by a processor, causes the processor to acquire a plurality of to-be-previewed images of the target sub-video by embedding the segment topic into corresponding respective images in the target sub-video.

In some embodiments, the at least one program, when loaded and run by a processor, causes the processor to embed the segment topic into the corresponding respective images in the target sub-video; and acquire the plurality of to-be-previewed images of the target sub-video by acquiring at least one of a brief introduction and a link entrance of the target sub-video and embedding at least one of the brief introduction or the link entrance of the target sub-video into the respective image in the target sub-video.

1. A method for playing back presentation videos, comprising:
displaying a playback interface for a presentation video in response to a trigger operation on the presentation video;
displaying a segment topic in the playback interface, wherein the segment topic is determined based on content identification of a segment in the presentation video; and
playing back a target sub-video corresponding to the segment topic in response to an operation on the segment topic, wherein the target sub-video comprises segments with a same segment topic, and is configured to play back the segments with the same segment topic successively.

2. The method for playing back presentation videos according to claim 1, wherein playing back the target sub-video corresponding to the segment topic in response to an operation on the segment topic comprising:
receiving the target sub-video from a server, wherein the target sub-video is acquired by reorganizing segments of the presentation video such that the segments with the same segment topic is capable of being played back successively.

3. The method for playing back presentation videos according to claim 1, wherein said displaying the segment topic in the playback interface comprises:
playing back a segment corresponding to a progress control operation in the playback interface and displaying a segment topic of the segment in response to the progress control operation on the playback interface.

4. The method for playing back presentation videos according to claim 3, wherein said playing back the segment corresponding to the progress control operation in the playback interface and displaying the segment topic of the segment in response to the progress control operation on the playback interface comprises:
displaying a target image in the playback interface in response to the progress control operation on the playback interface, wherein the target image is a frame of the presentation video, the segment topic is displayed in the target image, and a playback moment of the target image corresponds to a playback moment indicated by the progress control operation.

5. The method for playing back presentation videos according to claim 4, wherein said playing back the target sub-video corresponding to the segment topic in response to the operation on the segment topic comprises:
playing back the target sub-video corresponding to the segment topic with the playback moment of the target image as a starting point in response to the operation on the segment topic.

6. The method for playing back presentation videos according to claim 1, further comprising:
playing back the presentation video with a playback moment at which playback of the target sub-video begins in the presentation video as a starting point in response to an ending of the playback of the target sub-video; or
stopping playing back the target sub-video and playing back the presentation video with a playback moment at which playback of the target sub-video begins in the presentation video as a starting point in response to an operation to stop playing back the target sub-video.

7. The method for playing back presentation videos according to claim 1, further comprising:
playing back the target sub-video in response to a playback operation on the target sub-video, wherein the target sub-video is identified by a name, an image or a segment topic, and identification of the target sub-video is configured as a control on which upon the playback operation, cause the play back of the target sub-video.

8. A method for identifying presentation videos, comprising:
acquiring segment topics of respective segments by performing content identification on the respective segments in a presentation video;
acquiring at least one target sub-video by reorganizing segments with a same segment topic, wherein each of the at least one target sub-video corresponds to one of the segment topics; and
embedding the segment topic into the corresponding target sub-video.

9. The method for identifying presentation videos according to claim 8, wherein said acquiring the segment topics of the respective segments by performing the content identification on the respective segments in the presentation video comprises:
acquiring a plurality of images and a plurality of audio segments of the presentation video;
determining a first content topic of each of the images and determining a second content topic of each of the audio segments, wherein the first content topic is determined by an image identification model, and the second content topic is determined by an audio identification model; and
determining a segment topic of each of the segments based on the first content topic and the second content topic that correspond to each of the segments in the presentation video.

10. The method for identifying presentation videos according to claim 9, wherein said determining the segment topic of each of the segments based on the first content topic and the second content topic that correspond to each of the segments in the presentation video comprises:
acquiring, with respect to any one of the segments, a first target content topic of the segment, wherein the first target content topic is a first content topic with a largest number of the first content topics in at least one of the first content topics of the segment;
acquiring a second target content topic of the segment, wherein the second target content topic is a second content topic with a largest number of the second content topics in at least one of the second content topics of the segment;
acquiring a sum value by performing a weighted summation on the number of the first target content topics and the number of the second target content topics in response to the first target content type being the same as the second target content topic; and
determining the first target content topic as the segment topic of the segment in response to the sum value satisfying a predetermined condition.

11. The method for identifying presentation videos according to claim 8, wherein said acquiring the at least one target sub-video by reorganizing the segments with the same segment topic comprises:
determining, from a plurality of segments of the presentation video, the segments with the same segment topic; and
reorganizing the segments with the same segment topic by splicing and generating the target sub-video.

12. The method for identifying presentation videos according to claim 11, further comprising:
in response to a playback request from a terminal for the target sub-video, transmitting the target sub-video to the terminal;
wherein the playback request is transmitted by the terminal after triggering the segment topic.

13. The method for identifying presentation videos according to claim 8, wherein said acquiring the at least one target sub-video by reorganizing the segments with the same segment topic comprises:
determining, from a plurality of segments of the presentation video, the segments with the same segment topic; and
associating playback moments of the segments with the same segment topic with the segment topic.

14. The method for identifying presentation videos according to claim 13, further comprising:
in response to a playback request transmitted by a terminal, associating playback moments with a segment topic carried by the playback request; and
transmitting a segment corresponding to the playback moments to the terminal, wherein the terminal is configured to play back the segment corresponding to the playback moments;
wherein the playback request is transmitted by the terminal after triggering the segment topic.

15. The method for identifying presentation videos according to claim 8, wherein said embedding the segment topic into the corresponding target sub-video comprises:
acquiring a plurality of to-be-previewed images of the target sub-video by embedding the segment topic into respective images in the corresponding target sub-video.

16. The method for identifying presentation videos according to claim 15, wherein said acquiring the plurality of to-be-previewed images of the target sub-video by embedding the segment topic into the respective images in the corresponding target sub-video comprises:
embedding the segment topic into the respective images in the corresponding the target sub-video; and
acquiring the plurality of to-be-previewed images of the target sub-video by acquiring at least one of a brief introduction and a link entrance of the target sub-video and embedding the at least one of the brief introduction or the link entrance of the target sub-video into the respective images in the target sub-video.

17. A computer device, comprising a processor and a memory, the memory storing at least one program therein, wherein the at least one program, when loaded and run by the processor of the computer device, causes the computer device to:
display a playback interface for a presentation video in response to a trigger operation on the presentation video;
display a segment topic in the playback interface, wherein the segment topic is determined based on content identification of a segment in the presentation video; and
play back a target sub-video corresponding to the segment topic in response to an operation on the segment topic, wherein the target sub-video comprises segments with a same segment topic, and is configured to play back the segments with the same segment topic successively.

18. The computer device according to claim 17, wherein the at least one program, when loaded and run by the processor of the computer device, causes the computer device to:
display, in an image currently played back in the playback interface, a segment topic of a segment to which the image belongs; or
play back a segment corresponding to a progress control operation in the playback interface and display a segment topic of the segment in response to the progress control operation on the playback interface.

19. The computer device according to claim 18, wherein the at least one program, when loaded and run by the processor of the computer device, causes the computer device to:
display a target image in the playback interface in response to the progress control operation on the playback interface, wherein the segment topic is displayed in the target image, and a playback moment of the target image corresponds to a playback moment indicated by the progress control operation.

20. The computer device according to claim 19, wherein the at least one program, when loaded and run by the processor of the computer device, causes the computer device to:
play back the target sub-video corresponding to the segment topic with the playback moment of the target image as a starting point in response to the operation on the segment topic.
